(19) United States
(12) Patent Application Publication
(10) Pub. No.: US 2004/0103022 A1
(43) Pub. Date: May 27, 2004

(54) Method and system for web-based marketing of goods and services having incentive features, tracking and processing incentive based marketing data

(76) Inventors: Charles B. Chilcoat III, Ellicott City, MD (US); John Paul Kosciusko, Jefferson, MD (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/300,635

(22) Filed: Nov. 21, 2002

(51) Int. Cl. G06F 17/60

(52) U.S. Cl. 705/14

(57) ABSTRACT

Web-based marketing of goods and services having incentive features, referral process, and tracking the earned incentives includes a software running on a central computer, which, upon initialization of a referral activity by a current client, presents to the client templates formatted in compliance with rules and regulations of industry. Once a template is accepted by the current client, the software e-mails the template to a prospective purchaser, whose name and e-mail address is submitted by the current client. Once the prospective purchaser has made a purchase, the software tracks the earned incentive to the referring current client and credits his/her account.

### FIELD OF THE INVENTION

The present invention relates to marketing of goods and services having an incentive feature associated therewith, and more particularly to the referral process associated with purchasing of goods or services over a computer network.

The present invention further relates to a referral assignment process, as well as to a customer account referral and tracking process and system. The system and method further provides for processing sales and marketing data for purchased goods and services over the Internet.

The present invention additionally relates to a method and system for processing information related to insurance policies having a rebate feature.

In overall concept, the present invention furthermore relates to the referral technique in which a current client (referrer) of an insurance agency selects an e-mail template from a selection provided by the insurance agency, enters e-mails and names of referees to which the selected template is to be e-mailed by the insurance agency. The database of names and e-mails of referees is matched with the referrer upon the purchase of an insurance policy by the referee. Each template is formatted in compliance with rules and regulations associated with the insurance industry.

### BACKGROUND OF THE INVENTION

With the advent of the Internet and the development of new marketing systems, the world of commerce has changed dramatically for small and large companies, as well as for individual entrepreneurs. As a result of the proliferation of on-line sales through the Internet, doing business has been profoundly impacted through such means as easily-attained affiliations with other business entities over the Internet. For example, an individual entrepreneur may open an online “super mall” on the Internet with little or no investment and with minimum time expenditure.

One of the marketing systems used for selling goods or services over the Internet is known as Multi-Level Marketing (MLM). MLM is a marketing system in which a participant may sign up others to assist in sales activity, and they, in turn, recruit other participants to assist them. In this manner, upline and downline participants create a hierarchical network for marketing products and services to consumers as well as to one another. Some entrepreneurs have built successful companies utilizing the MLM concept by focusing their activities on their product and product sales.

One prime example of such an MLM company is Amway which has built a multi-billion dollar business by selling home products through affiliated distributors that encourage others to participate in the sales of goods. The MLM concept has also been applied to, among other things, marketing computers, jewelry, nutrition and health products, publications, etc. In addition to marketing goods, MLM has also been applied to marketing software and travel services.

The use of Multi-Level Marketing systems, however, has not been without controversy. The system has been praised for placing commerce within the reach of a large number of small business operators. At the same time, other MLM variations have been criticized for being no more than an illegal “pyramid” scheme. In contrast to a legitimate MLM distributorship, which focuses on a particular product and product sales, the success of a pyramid distributorship for each and every distributor depends on continuously obtaining additional people to join in a pyramid that offers hierarchical levels of reward.

Due to the theoretical limit on the number of participants and product units that can be sold, the pyramid participants often pay high entrance fees. Such persons can earn money by concentrating most, if not all, of their efforts on recruiting other participants rather than emphasizing the sale of products. Since these types of pyramid schemes include all three elements of a lottery (prizes, chance, and consideration), fraudulent pyramid schemes typically violate the Federal and State Statutes. Consequently, the main difference between a legitimate MLM system and an illegal pyramid scheme lies in whether the basis of the promotion is the legal retail sale of products or an emphasis on recruiting more distributors to increase income.

Due to its much wider reach, the Internet provides an ideal channel for extending the application of MLM to many different kinds of goods and services. Some MLM programs offered over the Internet have incentive features associated with a referral activity performed by a number of referrer participants in connection with a corresponding plurality of referee participants. One such incentive-based MLM program involves investing in the stock market over the Internet where investors may periodically earn monetary bonuses by referring new investors to the site.

Computer data processing, programming and printing have been used in connection with incentive award programs. For example, U.S. Pat. No. 6,029,141, entitled “Internet-based Customer Referral System”, discloses an Internet-based referral system that enables individuals and other business entities (“associates”) to market products in return for a commission that are sold from a merchant's Web site.

The system includes automated registration software that runs on the merchant's Web site to allow entities to register as associates. Following registration, the associate sets up a Web site (or other information dissemination system) to distribute hypertextual catalog documents that includes marketing information (product reviews, recommendations, etc.) about selected products of the merchant.

In association with each such product, the catalog document includes a hypertextual “referral link” that allows a user (“customer”) to link to the merchant's site and purchase the product. When a customer selects a referral link, the customer's computer transmits unique IDs of the selected product and of the associate to the merchant's site allowing the merchant to identify the product and the referring associate. If the customer subsequently purchases the product from the merchant's site, a commission is automatically credited to an account of the referring associate. The merchant site also implements an electronic shopping cart that allows the customer to select products from multiple different Web sites, and then perform a single “check out” from the merchant's site.

In U.S. Pat. No. 5,537,314 entitled “Referral Recognition System for an Incentive Award Program”, there is disclosed a credit accumulation and accessing system for a plurality of sponsoring companies and participants. Through a central control center each sponsoring company connects to a multiplicity of second-sponsoring companies and a plurality of financial institutions. In such a system, sponsoring company, participant, performance data, along with award conversion tables, pyramidal association tables, award applicable merchandise UPC codes, financial-institution-issued lines of credit and computer operational programming are stored.

Under control of the operational program several tasks are accomplished including creating subdirectories with multiple sponsoring company accounts, in accordance with performance of participants, while sending results immediately and/or periodically to appropriate destinations.

Another example of an incentive-based program is disclosed in U.S. Pat. No. 5,025,372 entitled “System and Method for Administration of Incentive Award Program Through Use of Credit”. According to the disclosed program, monetary amounts available for expenditure through credit instruments, such as credit cards, are issued to program participants when the participants perform to a designated level of achievement.

Participants identifying information and credit instrument account numbers are stored in memory. The incentive program can be divided into multiple time periods. Levels of performance are calculated and assigned for each participant in order for a monetary amount to be available for expenditure through the participant's credit instrument. Monetary amounts may be withheld from the amounts allocated to the instrument accounts. Adjustments may be made in the withheld amounts and in the achievement levels. Calculations, adjustment and reporting concerning amounts allocated for instrument use, withheld amounts, instrument transactions and account balances are made. Calculations and printed invoices for payment by a financial institution to an incentive company based on the credit instruments issued under the incentive program are made and are dependent upon the monetary volume of expenditures through the credit instruments, the total interest income on the credit instruments, and the number of instruments issued. The tradename or trademark of the company sponsoring the program may appear on the physical credit instruments and on statements provided to participants. Travel and merchandise awards are integrated with the credit instrument program.

In order to support an MLM system over the Internet, knowledge management tools have also been developed for managing upline, downline and prospect information.

However, conventional approaches for tracking the participant information of incentive-based marketing programs offer limited features that are not web-enabled and rely substantially on manual host or client-based data entry slowing and thereby complicating the tracking process. Therefore, there exists a need for simplifying participant tracking preferably by taking advantage of Internet-related features. More particularly, there is a need for a web-enabled solution for tracking earned incentives associated with purchasing goods or services having an incentive feature associated with a referral activity performed by a referrer participant in connection with at least one referee participant.

Although some referral bonuses are monetary payments, other types of incentive features include discount rebates, such as a percentage discount for a product price or service premium. As is well known, marketing of certain services to consumers is regulated by rules set forth by a particular industry or mandated by federal or state governments. For example, a state insurance commission at the state level regulates insurance marketing, whereas both state and federal agencies may govern marketing of securities.

In a 1988 referendum, Proposition 103 was passed in California removing the prohibition against insurance commission rebating to consumers, the objective was to lower insurance premiums in that State. Thus, insurance agents were permitted to offer premium rebates, as taken from their commission, to policyholders and others with an insurable interest in the State of California as long as the rebate amount may not exceed the insurance policy premium.

Some insurance agents have offered allegedly low-cost insurance policies over the Internet (for example, from a computer list), by advertising insurance commission rebates as a percentage of the policy premium. Conventionally, such incentive-based rebates have been applied on a policy-by-policy basis to the policy premiums of term, universal or whole life insurance, although not using referrer-referee model but simply an agent's return of a portion of commission on that policy. This insurance premium rebating approach calculates the rebates associated with an individual's own premium, as opposed to rebates associated with the premium of other referred participants. However, insurance premium referral rebates for insurance premiums of referred participants could legally be paid only when the referral function performed by an individual policyholder is not considered insurance solicitation by an unlicensed individual.

Another example of marketing products in a regulated industry includes soliciting investors with regards to securities. The solicitation of such services generally requires a license from a designated governmental or industry agency. Therefore, there exists a need for a process that permits unlicensed individuals to transact business in an otherwise regulated industry.

### SUMMARY OF THE INVENTION

It is an object of the present invention to provide a web-based solution for enabling tracking and processing incentive-based marketing data relating to marketing goods and services in regulated industries by unlicensed individuals, such as the insurance industry.

It is another object of the present invention to provide a referral process, as well as a referral assignment and tracking process, for processing earned incentive data associated with purchasing goods or services over a computer network.

It is a still further object of the present invention to provide a web-based referral process, rating engine, and account management function where a current client of a regulated business provides a list of names and e-mail addresses to which he desires information on a product to be forwarded. Additionally, information is stored in a data base of the regulated business and tagged with the client's name and identifying information, in order that the regulated business sends the information about goods and services provided by the business to the people (or companies) from such a list. In this manner, the transaction of a regulated business is separated from the actions of unlicensed participants (clients of the insurance agency).

Another object of the present invention is to provide the referral technique, in which the client (referrer), who is a client of a regulated business, selects an e-mail template from a selection provided by the regulated business, then enters the e-mail and name to which these templates are to be addressed via web based e-mail. The data base of names and e-mails of prospective referees is used by the regulated business for subsequently matching with the referrer when the prospective referees purchase goods and/or services provided by the regulated business.

It is a further object of the present invention to provide a referral process associated with purchasing goods and/or services of regulated businesses where a match between the referrer and referee is established and where the progress and/or status of the earned incentives are readily available for viewing by the referrer in the form of a premium summary of the account of the referrer, a rebate summary presenting to the referrer the name of his referees, coverages they have purchased, the annual premium for each of these coverages, and applicable calculated rebate percentages. The “tracker” presents to the referrer the monthly accounting for premiums earned, rebates earned, and the net cost of insurance.

In accordance with one concept, the present invention provides a method of referring new, prospective purchasers of services or goods over the Internet by a current owner or user of such goods and/or services provided by a regulated business. Additionally, this invention provides a technique for properly matching the referrer party to the referee party once the services and/or goods are purchased by the referee party in order to provide full reward to the referrer party on his/her referral activity. Although based on the mailing list provided by the referrer party, the process uniquely separates the transactions of the regulated business from the actions of unlicensed participants by means of using electronic messages (templates) formatted in compliance with regulation in the industry in which the business operates.

The method of the present invention comprises the steps of:

receiving a signal indicative of initialization of a referral activity by an owner/user of at least one good or service at a central computer from at least one station (the owner of the good or the service is considered herein as the “referrer entity”),

sending at least one electronic message to the station associated with the referrer template appropriately formatted to be in compliance with a predefined rule or regulation normally directing the recipient to the opportunity to purchase a regulated good or service from an appropriately licensed entity and the item has an incentive feature associated therewith,

receiving and storing in a data base at said central computer, referral activity data associated with the referrer entity and with at least one referee entity,

receiving at the central computer from the referrer entity a signal indicative of approval of the formatted electronic messages,

sending the approved, formatted, electronic message from the central computer to a station associated with at least one referee entity,

matching the referrer entity with at least one referee entity based on the referral activity data, and

electronically crediting the account associated with the referrer entity based on a predetermined incentive criteria associated with the referral activity once the item has been purchased by the at least one referee entity.

Each referee entity who has purchased a product is offered an option of accepting or declining a referrer entity. For this, the data representing the referrer entity is shared with the referee entity for acceptance or refusal. Upon accepting the referrer entity, the account of the referrer entity is credited. If however, the referee entity declines the referrer entity the referee entity is offered an alternative referrer entity.

In the case where a new policyholder has no referrer, they may be assigned as a referee to an existing client based upon predefined protocols.

The method of the present invention for marketing goods and services, as well as for tracking earned incentives, further includes the option of displaying account information at the station associated with the referrer entity. This includes premium summary information, rebate summary information, and information associated with other earned incentives that may be available to the referrer entity.

The referral activity data has identification fields identifying the referrer entity and the referee entity. The identification fields correspond to at least one of the electronic mail addresses of either the referrer entity or referee entity.

The method is generally based on Internet communication where the goods and services are marketed over the Internet. The referral activity data is received from the plurality of stations running at least one Internet browser. The referral activity data is also received at a server station running at least one data base application (either actual or virtual).

Although the method of the present invention may be applied to any product, good or service to be marketed, in one embodiment the method is applied to an insurance policy which may be either property and casualty insurance, financial services policy, or health insurance, etc.

The incentive feature of the item marketed is a rebate feature and the predetermined incentive criteria is a percentage of the premium of the referred insurance policy.

The referral activity of the referrer entity may involve announcing at least one of the incentive features of the insurance policy to a third party.

The present invention is also directed to a method for processing insurance policy-related information, including the steps of:

offering an insurance policy having a rebate feature available if a qualifying activity (referral activity) is performed by the insurance policyholder;

receiving data associated with the referral activity performed by the insurance policyholder;

calculating rebates associated with the premium of the insurance policy based on the received referral activity data; and

presenting to the insurance policyholder discount information based on the calculated rebate data.

In this method based on the referral activity data and a predetermined incentive criteria associated with referral activity, the method further includes the steps of calculating a rebate associated with the premium of the insurance policy owned by the holder,

crediting the insurance policy holder account with a rebate; and

displaying the holder account information on a display.

The present invention further provides a system for marketing products and for tracking earned incentives associated with purchasing of the products. Such a system includes:

a central computer,

a plurality of users linked via their own stations to the central computer in a computer network, each user being a respective current holder of at least one of the marketed products,

a mechanism at the central computer for sending to the users electronic messages formatted in compliance with a predefined regulation, the electronic messages being representative of at least one item from the products to be marketed, the said at least one item having an incentive feature,

a mechanism at the central computer for receiving from the users and storing in the central computer referral activity data associated with the respective current holder of the product and with at least one prospective holder of the product to be marketed,

a mechanism for sending the formatted electronic messages from the central computer to a user associated with at least one prospective holder of at least one item upon approval by the respective current holder of the product,

a mechanism in the central computer for matching the respective current holder of the product with the prospective holder of the product based on the referral activity data, and

a mechanism at the central computer for associating and crediting the respective current holder's account, once the item has been purchased by the aforementioned prospective holder, now a policyholder.

The system further comprises a display for displaying information regarding the respective current holder account including confirmation related to the earned incentives as a result of referral activity performed by the respective current holder of the product.

These, and other, novel features and advantages of this invention will be fully understood from the following detailed description and the accompanying Drawings.

### BRIEF DESCRIPTION OF THE DRAWINGS

FIG. 1 is a schematic representation of the system of the present invention for marketing products and for tracking incentives earned as the result of the referral activity;

FIG. 2 is a schematic representation of the impact of the referrals on the insurance policy premium;

FIG. 3 is a flow chart diagram of the initial process and acquiring an indication rate for purchasing goods or services;

FIG. 4 is a flow chart diagram of a quote process;

FIG. 5 is a flow chart diagram of a referral process of the present invention;

FIG. 6 is a flow chart diagram of a referral assignment process of the present invention;

FIG. 7 is a flow chart diagram of a customer account referral and tracking process of the present invention;

FIG. 8 illustrates a web site of the virtual premium program of the present invention for initialization of the process of Internet based referral activity;

FIG. 9 illustrates a sample of the page presented to a referrer to perform his/her referral activity;

FIG. 10 is a representation of a premium summary of the referrer entity;

FIG. 11 is a representation of a rebate summary of the referrer entity; and,

FIG. 12 is a tracker screen of the referrer entity.

### DESCRIPTION OF THE PREFERRED EMBODIMENTS

Although the system and method of the present invention is applicable to marketing of any goods, services, and/or products, and for tracking earned incentives associated with purchasing such goods, services, and/or products over a computer network, for the sake of explanation, further description of the present invention is given with association to insurance policy marketing.

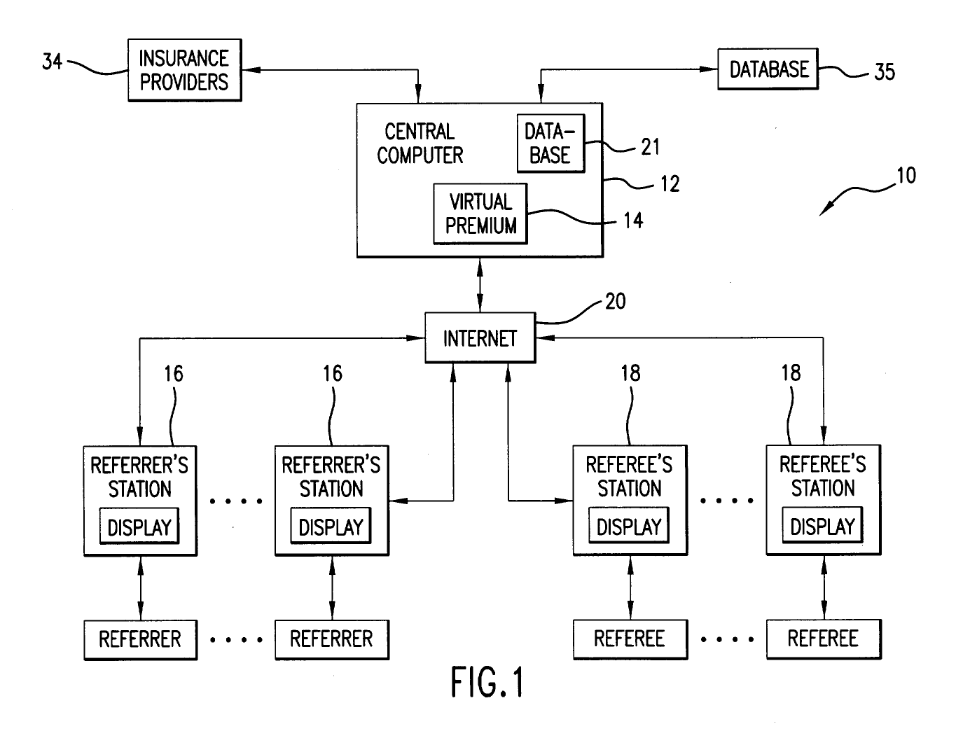

Referring to FIG. 1, the system 10 of the present invention includes a central computer 12 where Virtual Premium (VP) software 14 is installed, a plurality of referrer's stations 16, as well as a plurality of referee's stations 18 networked to the central computer 12 through the Internet 20. The Virtual Premium software 14 represents a virtual premium (VP) entity having a web site. Visitors to the web site are able to shop for a number of lines of insurance, such as: Automobile, homeowner's, tenant's, umbrella, business, life insurance, annuities, etc.

For each of these lines of insurance, visitors to the VP web site are able to view policy provisions, obtain rates, and purchase insurance policies. The web site provides information on the products which several major insurance carriers (providers) 34 offer in all lines of coverage. The visitors to the web site have the option of obtaining “indication” rates or, upon request, full quotes. “Indication” rates are provided using standard rating software that offers rates based on an algorithm that assesses the risk factors of the individual based on a short list of questions. Shoppers may repeat the quotes process as many times as desired.

Once the visitors to the VP web site have completed the short form and found the sample rates to be competitive, visitors may request a telephone consultation with a licensed customer service representative through whom they may purchase an insurance policy.

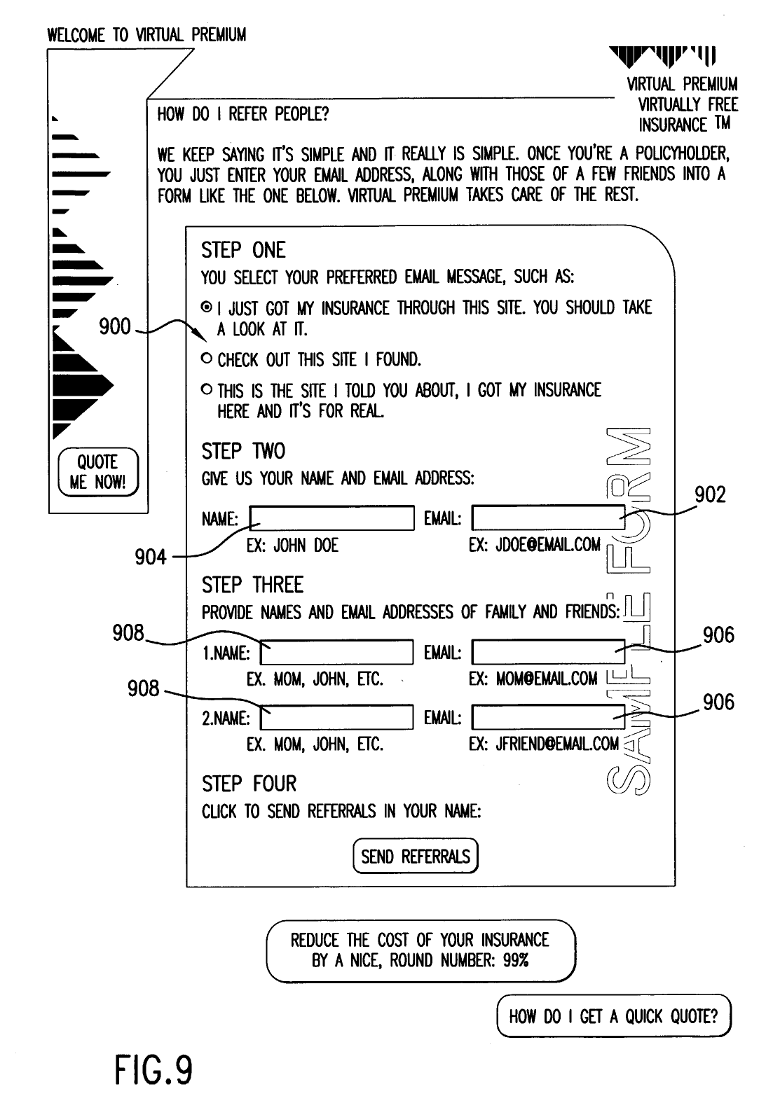

Once an individual has purchased insurance through the VP system, they are sent to a referral site best shown in FIG. 9 where they are prompted to enter a list of names and e-mail addresses to which they desire information on the Virtual Premium system to be forwarded. The e-mail information is captured in a data base and tagged with the original referrers' name and identifying information. The referral site also offers to the referee a list of templates, i.e., texts for electronic mail referrals, written to be in compliance with rules, standards and practices of a regulated industry. Such templates may include the following text:

Template #1

Check out this site I found, and let me know what you think.

Template #2

This is the site I told you about. I got my insurance here and it is for real!

Template #3

I just got my insurance through this site. You should take a look at it.

Template #4

You might have heard about this site. Take a look at it. It really works!

Template #5

This is great. I just bought my insurance through here. Take a look and let me know what you think.

Template #6

A friend of mine told me about this site. It's incredible and it works!

These texts are presented to the referrer for accepting of the most appropriate one to be e-mailed to a referee.

Until the referee either actively rejects continued mailings or they purchase insurance, the e-mail data base will continue to send rotating templates to each of the referees. When one of these individuals purchases insurance, the data base presents to the new buyer the one or more referrers on whose list they appear. The new buyer then chooses their referrer from that list, or selects another current client of Virtual Premium. As successful referrals are made, the original referrer is notified and his account is populated with information necessary for tracking the referee entity to the referrer entity as will be described in detail in later paragraphs.

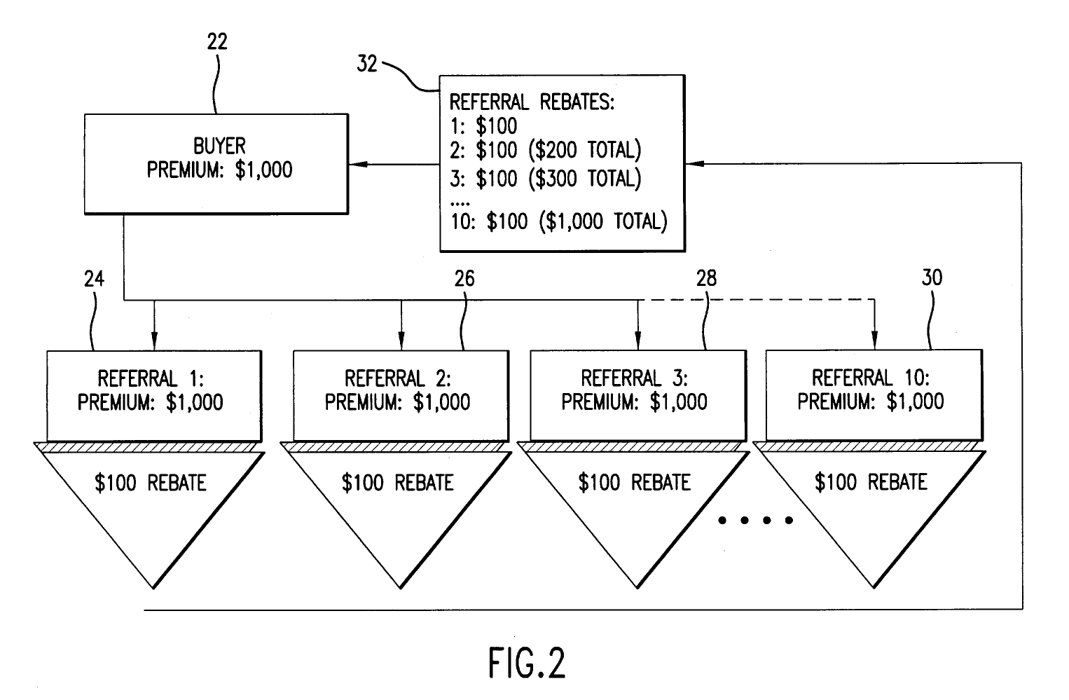

FIG. 2 schematically illustrates the impact of the referral activity on the premiums of the referrer's entity. For instance, as shown in FIG. 2, a current client 22 of an insurance company owns an insurance policy for which its original premiums are $1,000.00. By referring a potential client 24 who will buy the insurance policy with a premium of $1,000.00, the current owner 22 of the insurance policy will receive a $100.00 rebate. In the same manner, the current owner 22 of insurance policy receives a $100.00 rebate from the prospective clients 26 through 30. The referral rebates are summarized in box 32, and are applied to the premium $1,000.00 of the current owner 22 thus reducing the premium of the current owner.

The Virtual Premium system provides for a convenient referring process where referrals call for no more action on the part of the referring party (current owner, 22, of the insurance policy) other than to refer them to the Virtual Premium web site. There are no further obligations and there is no need for the referring party (current owner, 22) to continue to refer prospective clients of the insurance company to the VP web site in order to “bolster” the current owner's, 22, income. Once the single insurance policy purchase is made by any of the referrals 24 through 30, and for as long as their policies remain in force, a rebate is earned by the current owner, 22. Since there are no direct sales on the part of the referring individual (current owner 22) no licensing of such an individual is necessary.

The upper limit on the amount of a rebate an individual (current owner 22) may accumulate is equal to their premiums payable on policies purchased through Virtual Premium. How quickly the referrer entity accumulates 100 percent reimbursement on his premium, depends upon three variables:

1. The premium of the original policy of the current owner, 22;

2. The percentage rebate;

3. The premium of the referred policy of any and all referral 24 through 30.

It is important that the initial premium system of the present invention is advantageous to the referrers, the insurer, and the VP entity. For the referrers, their net cost of insurance drops as a result of the referral process. With as few as two referrals, the current owner of an insurance policy is able to lower their net cost of coverage significantly.

For the insurer, 34, (insurance company providing the insurance policy), the benefits are as follows:

they obtain through the Internet a customer from a generally affluent and responsible population;

they hold a customer for an extended period of time, since changing carriers of the insurance policy may mean losing rebates;

they experience fast growth with low acquisition cost since the Virtual Premium system processes applications, thus reducing the load on the insurance provider 34 as best shown in FIG. 1.

The Virtual Premium entity and its investors receive the following benefits:

a system of viral marketing where customers are compelled to refer others;

customers for an extended period of time;

a bottom line that grows rapidly with every new customer;

reduced acquisition cost for each new customer.

The enabling technology for the Virtual Premium system of the present invention is the World Wide Web, augmented by online rating technology and database functionality. With a robust web site as the centerpiece of the Virtual Premium system, it services a large number of individuals in real time through a 24/7 web connection. Key features of the Web site include:

Front-End

A web page provides information on the concept, its operation and potential. Virtual Premium is carefully and thoroughly explained with interactive examples of referral potential income.

Application

A rate “indicator” application that enables a customer, with fewer than a dozen clicks, to obtain a rough indication of what their rate may be is available on the site.

Should the customer be interested in pursuing an actual quote, they may schedule a telephonic appointment with a licensed customer service representative to obtain such a quote and to make a purchase.

Referral Functionality

Once a referring individual is a policyholder, he has the option of a self-service referral email that can be sent to his electronic mailing list, or to particular individuals. The email contains key information about Virtual Premium as well as a hyperlink back to the site. This assures referring individuals that their referrals are not lost. When a referral (referee entity) makes a purchase, the referring party is notified electronically.

Referral Management

With an account code and a password, a policyholder may, at any time, review his or her referral account status. Information on referred individuals is encoded to ensure privacy. The only data that is provided is the names of individuals the referrer has referred and the total number of policies, premiums and rebates attributable to their efforts.

Account Management

The site also permits policyholders to check the status of their own policies, browse policy provisions, and perform other self-service functions.

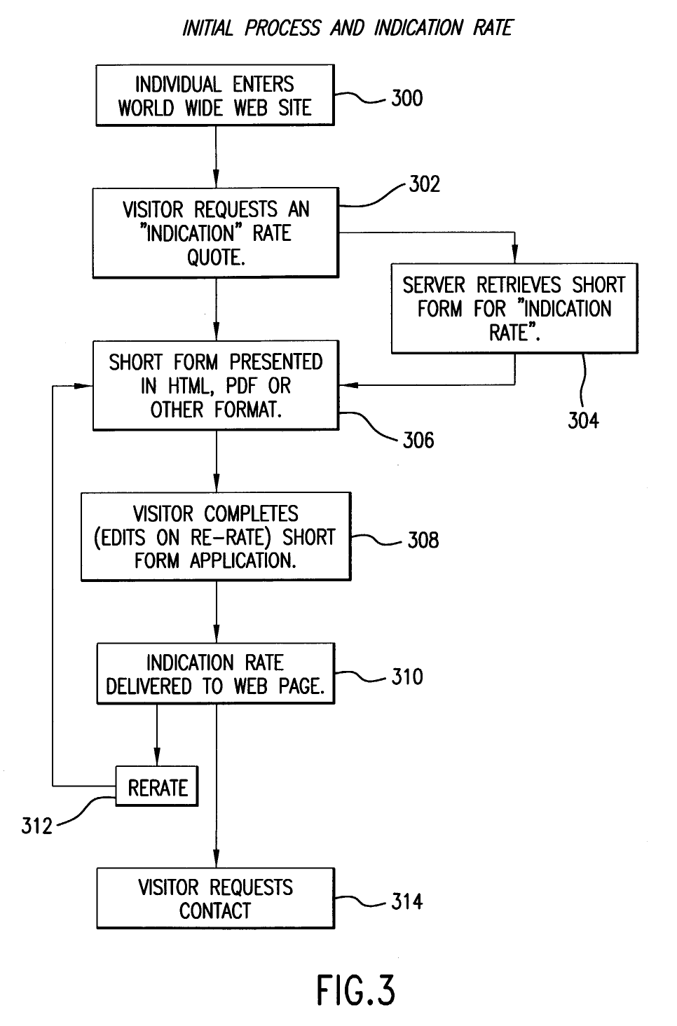

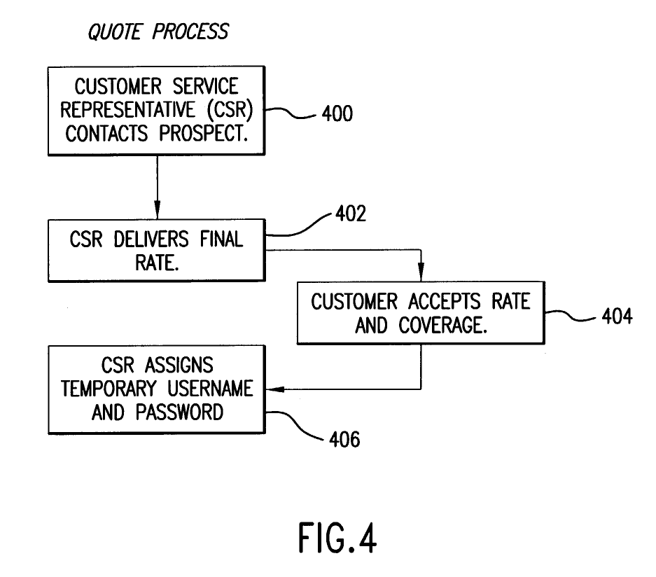

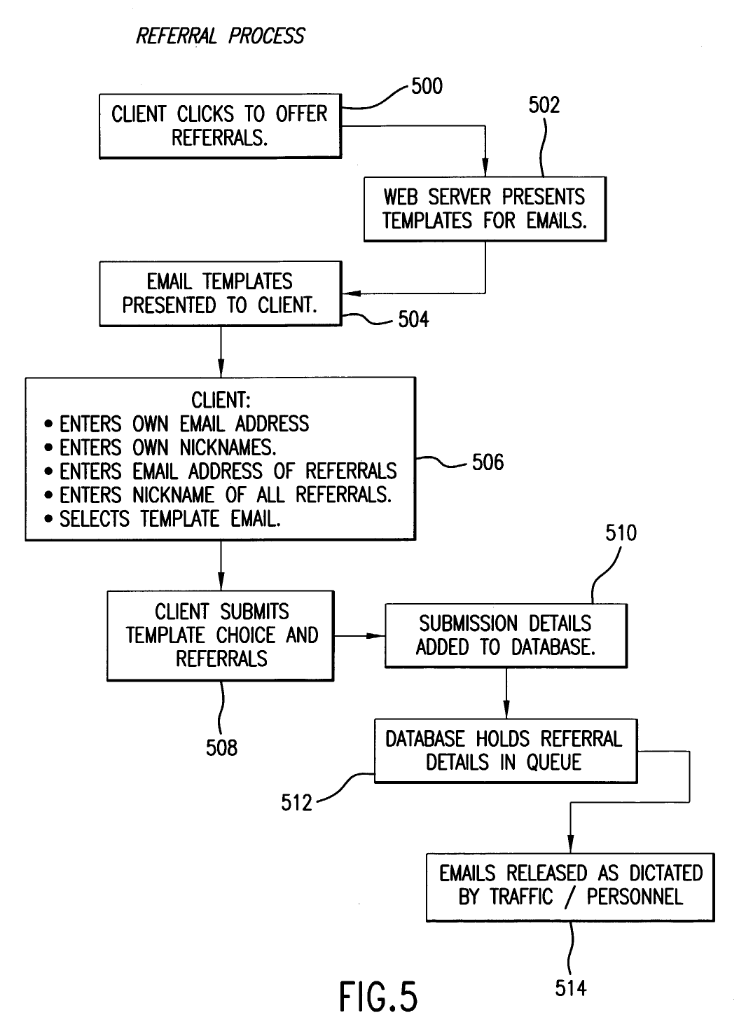

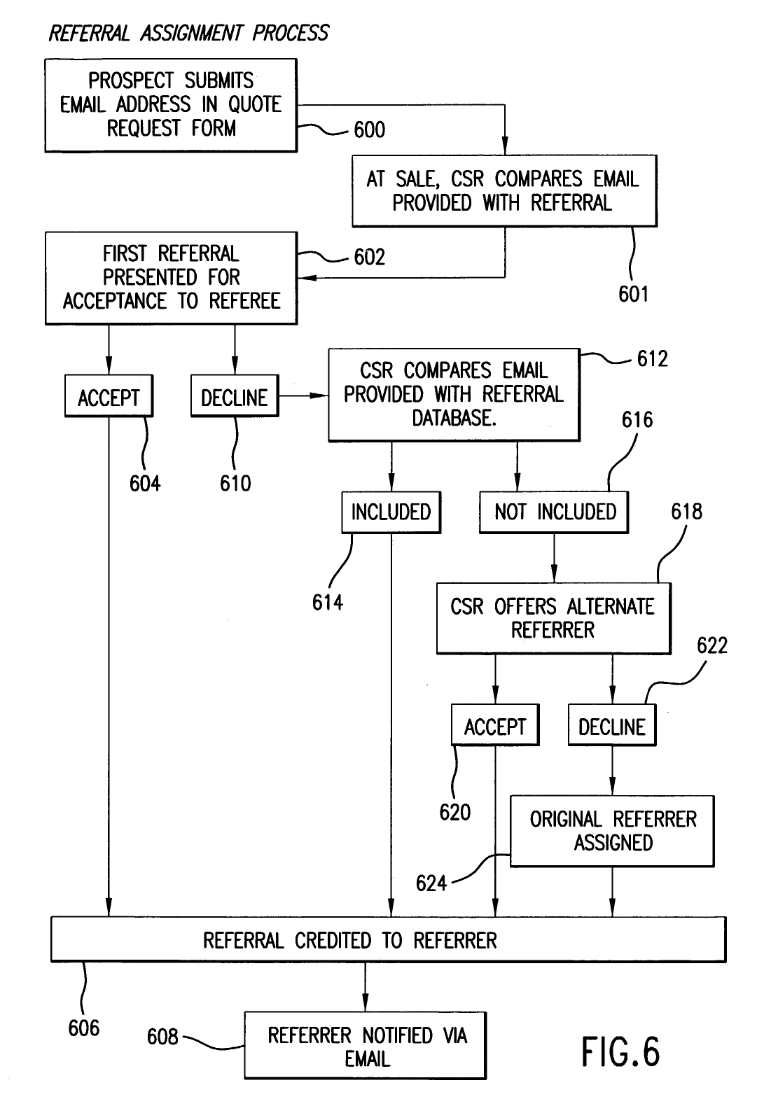

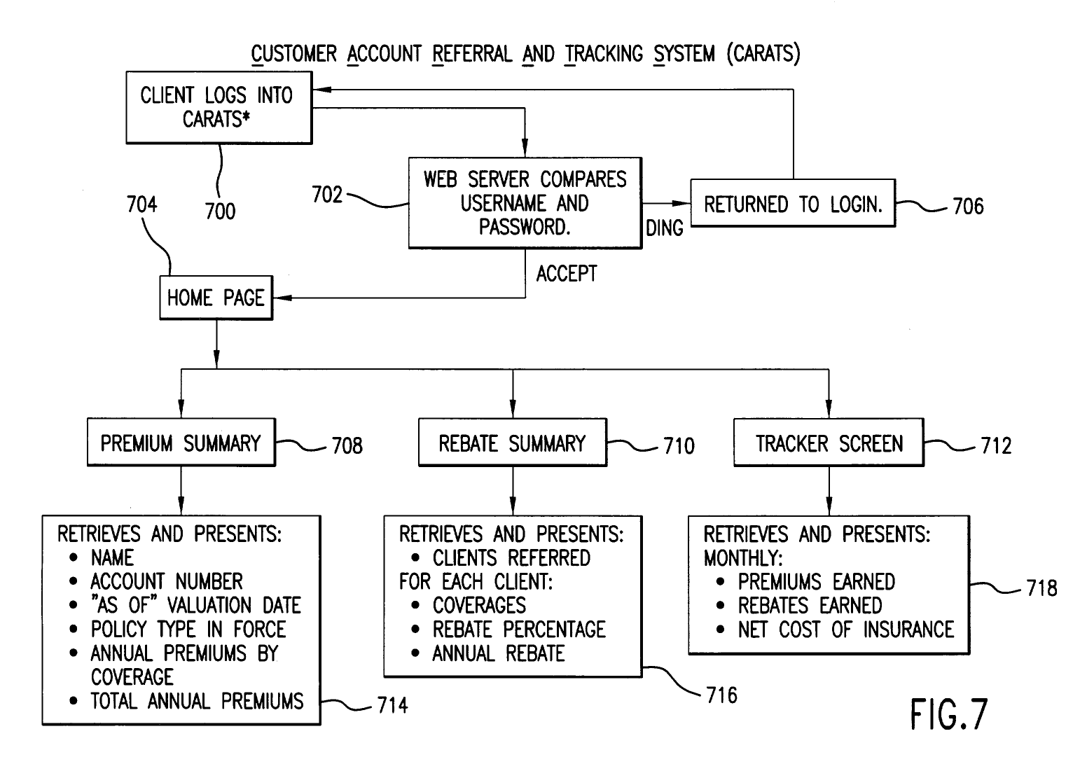

The Virtual Premium software 14, shown in FIG. 1, includes an initial process and indication rate obtainment (shown in FIG. 3), quote process (shown in FIG. 4), referral process (shown in FIG. 5), referral assignment process (shown in FIG. 6), and customer account referral and tracking process (shown in FIG. 7).

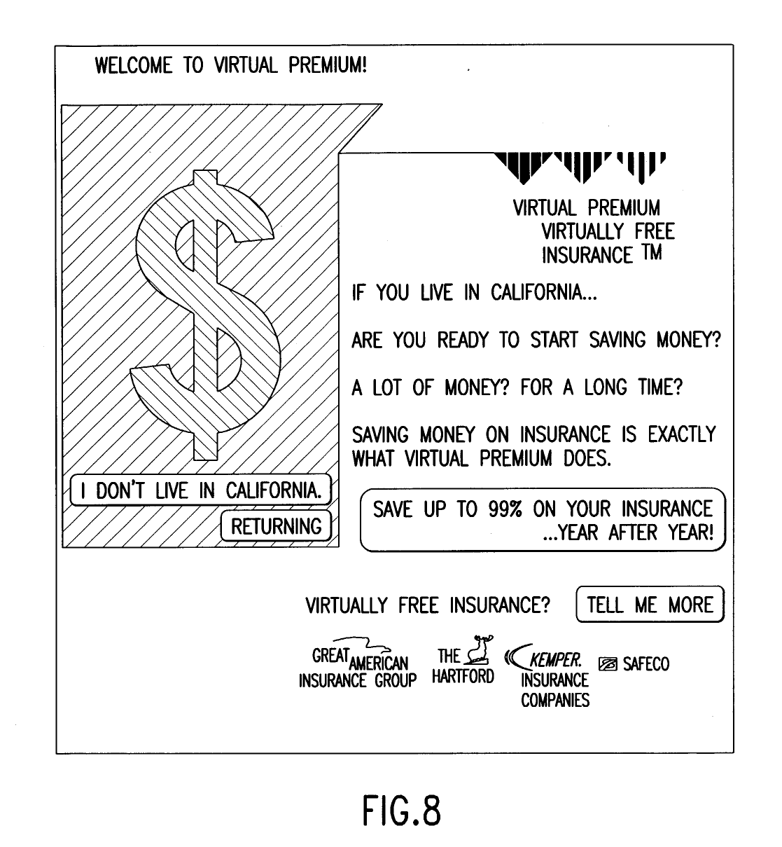

As shown in FIG. 3, presenting a flow chart diagram of the Initial Process and Indication Rate Process of the system of the present invention, an individual enters the Virtual Premium website at block 300 (the home page is shown in FIG. 8) and requests an indication rate at block 302. Indication rates are non-binding sample rates provided in response to a limited number of questions known as the “short form”. In response to the function of the block 302, the Virtual Premium software 14 (the server) retrieves the short form for indication rate in block 304, and further in block 306, the short form retrieved by the server in the block 304 is presented in HTML, PDF, or other well-known format.

The logic further flows to the block 308, where the visitor completes (edits or re-rates) the short form application and clicks to submit the filled short form application to the server. Further, the flow-chart moves to block 310, where the indication rate is delivered to the web page to be presented to the individual in response to the answers asked on the short form application.

If in block 310, the individual is not satisfied with the indication rate delivered, he has the option to “Re-rate” (312), and the flow chart loops back to the block 306. In this manner, the visitors are encouraged to go through the indication rate process as many times as they please, changing key pieces of information at each iteration to determine whether the rates are attractive enough to continue the process towards a full quote, which requests additional information and provides a binding quote. If, however, in block 310, the indication rate is satisfactory to the individual, the visitor requests contact with a sales representative in block 314.

As shown in FIG. 4, upon the visitor requesting a contact in block 314 of FIG. 3, in the Quote Process, a customer service representative (CSR) contacts the prospective buyer of the insurance policy, as shown in block 400. The visitor to the web site may bypass the indication rate process and may proceed directly to obtaining a full quote, as shown in FIG. 4.

In the block 400 the CSR completes a form that requests sufficient information from the prospective policyholder to determine a true and actual rate for insurance coverage from any or all of the carriers that are available on the web site. In the determination of the final rate, certain information will be collected by the customer service representative from other sources (such as, for example, the database 35, shown in FIG. 1) that will reflect the driving record and other data critical to the rating process.

If there is a discrepancy between the information provided on the application and that which is retrieved from the data base(s), the prospective customer will be notified and the rate will reflect this information found as opposed to that submitted. At the conclusion of this phase of the process, the customer service representative delivers a final rate to the customer in the block 402. The final rate includes the rates from each of the insurance carriers, 34 (shown in FIG. 1), which the customer service representative has selected as prospective insurance companies to proffer insurance for the needs of the prospective customer. Upon accepting the rate and coverage by the customer in the block 404, the customer service representative assigns a temporary user name and password to the customer (the user name and password can be changed by the customer at a later time).

This way, the prospective customer, block 300 of FIG. 3 becomes a current client of the Virtual Premium entity and can perform a referral process, the flow chart diagram of which is shown in FIG. 5. As shown, the flow chart of the referral process starts with the block 500 where the current client clicks respective buttons on the screen shown in FIG. 9 displayed on his/her station 16 (shown in FIG. 1) to offer referrals. Upon receiving a signal of starting the referral process in block 500, the logic flows to block 502, in which the web server of the Virtual Premium entity presents templates 900 (FIG. 9) for e-mails to individuals listed by the current client. Several templates 900 (FIG. 9) are presented to the client at the stations 16 (shown in FIG. 1) in block 504. For example, the templates may include text of the nature:

Template #1

Check out this site I found, and let me know what you think.

Template #2

This is the site I told you about. I got my insurance here and it is for real!

Template #3

I just got my insurance through this site. You should take a look at it.

Template #4

You might have heard about this site. Take a look at it. It really works!

Referring again to FIG. 5, the logic further flows to block 506 where the client enters his own e-mail address at the field 902 (FIG. 9), chosen nicknames in the field 904, e-mail addresses of referrals (referee entities) in the field 906, nicknames of all referrals (referee entities) at the field 908, and selects a template from the collection of the templates presented by the Virtual Premium software to the client.

In block 508 (FIG. 5), the client submits the choice of template and e-mail addresses and nicknames of the referrals to which the client wishes such a template to be addressed into the web-based e-mail function. The purpose of using the web-based e-mail as opposed to the standard e-mail function is for the Virtual Premium data base to capture the e-mails in a data base for subsequent matching when one of the referrals returns and purchases an insurance policy.

From block 508, the logic moves to block 510, where the submission details are added to a data base 21 (as shown in FIG. 1) maintained by the Virtual Premium software 14 in the central computer 12. The data base holds referral details in queue, as shown in block 512 of the flow chart of FIG. 5, and the e-mails (templates) are released and e-mailed to respective e-mail addresses as dictated by traffic/personal in block 514 as part of the referral process. Under the control of logic in block 514 (shown in FIG. 5), the Virtual Premium software 14 e-mails the templates selected by the client (referrer entity) to the referee's station 18 of the referee entities shown in FIG. 1, and this process of emailing the templates to the prospective clients of the VP system is repeated periodically until the prospective client (referee entity) actively rejects such contacts or until the prospective client purchases an insurance policy. Upon receipt of a declination for further e-mails from a referee entity, the referrer is notified. Should one of the referrals make a purchase, the selected referrer is similarly notified.

It is imperative in the Virtual Premium process that referrals be accurately captured and assigned to the referrer entity. This is accomplished through the referral assignment process, the flow chart diagram which is shown in FIG. 6. When a new prospect arrives (referee entity) and agrees to go through the quoting process to become a client, he will be asked to enter his e-mail address. The prospect then submits an e-mail address in quote request form in block 600 of FIG. 6. The customer service representative then compares e-mail provided by the new client with the e-mail provided by a current client (referrer entity) in block 601. Should the e-mail address provided by the new client match one in the data base that is assigned to the current client (referrer entity) or multiple current clients, the new client will be prompted to select the one, or one of those presented to receive credit for the referral activity. The new client is given the option to accept or decline the referrer entity. In this manner the first referral is presented for acceptance to the referee entity in block 602. If the new client accepts the referrer entity first on the list by oral telephonic acceptance to a CSR (block 604), the logic follows directly to the block 606 “Referral Credited to Referrer”, and the referrer is notified via e-mail that the purchase has been made in block 608.

If, however, in block 602, the new client declines the first referrer entity on the list by so telling a CSR (block 610) the logic flows to the block 612. The customer service representative compares the e-mail provided in block 600 with the data base of referrals of existing clients created in block 510 of FIG. 5. If the match is found (i.e., the c-mails submitted by the new client in block 600 is included in such a data base as presented in block 614 “Included”), the logic flows to the block 606 “Referral Credited to Referrer”. If however, the match is not found, i.e., the e-mail submitted by the prospective client in block 600 is not in such a data base (block 616 “Not Included”), the customer service representative offers, in block 618, an alternate referrer if one exists.

In this situation, the prospective client has potentially two choices: either to accept (block 620) the alternate referrer presented to the prospective client in the block 618 or to decline (block 622) such an alternate referrer. If the alternate referrer is accepted, the logic flows from block 618 to block 606 to credit the referral to the alternate referrer. If there was never an alternate referrer or if the alternate referrer is declined by the prospective client, the original referrer presented in block 602 is assigned to the prospective client in block 624 and the logic flows to the block 606 where the referral is credited to the first referrer presented in block 602. In order to present a first referrer in block 602, the logic sorts the data base of the referrals chronologically so that upon declining the first referrer, the logic may present an alternate referrer in block 618 after the first referrer entity.

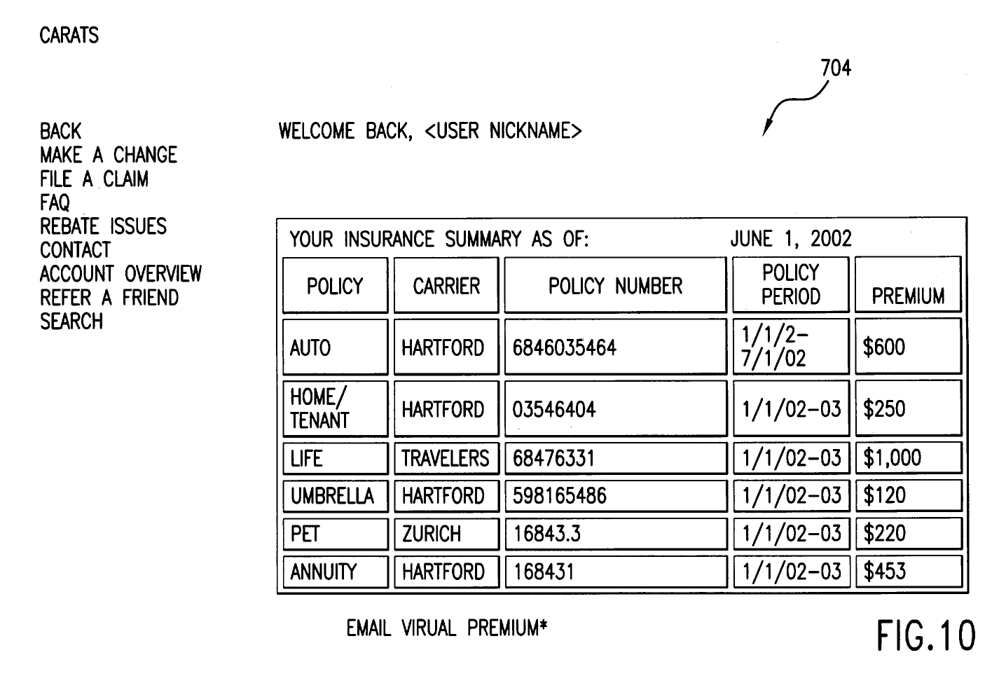

Upon being notified in block 608 of FIG. 6, the referrer may log into the Customer Account Referral and Tracking System (CARATS). The flow chart diagram of the CARATS process is shown in FIG. 7. When a client (referrer) logs into CARATS in block 700, the client is prompted for his user name and password. In block 702, the logic compares the user name and password with the user name and password existing in the data base 21 (shown in FIG. 1). The correct entry of this data will lead the client to the home page for CARATS in block 704. Such a home page for CARATS is shown in FIG. 10. This page serves as navigation to the balance of the VP system. If in block 702, the web server does not find a match between the entered password and user name and those saved in the data base, the logic flows from block 702 to block 700 through the block 706 “Return to Login”.

From the home page (block 704), upon receiving the command from the visitor, the logic flows to either of the blocks 708 “Premium Summary”, 710 “Rebate Summary”, or 712 “Tracker Screen”. The three main pages of CARATS house the three main functions of the system:

premium summary shown in FIG. 10,

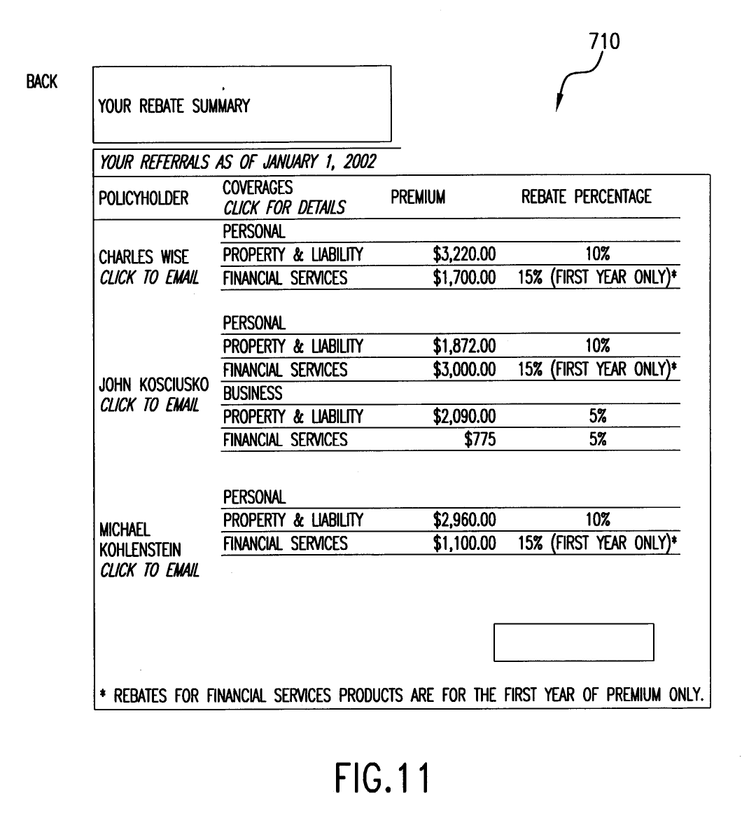

rebate summary shown in FIG. 11,

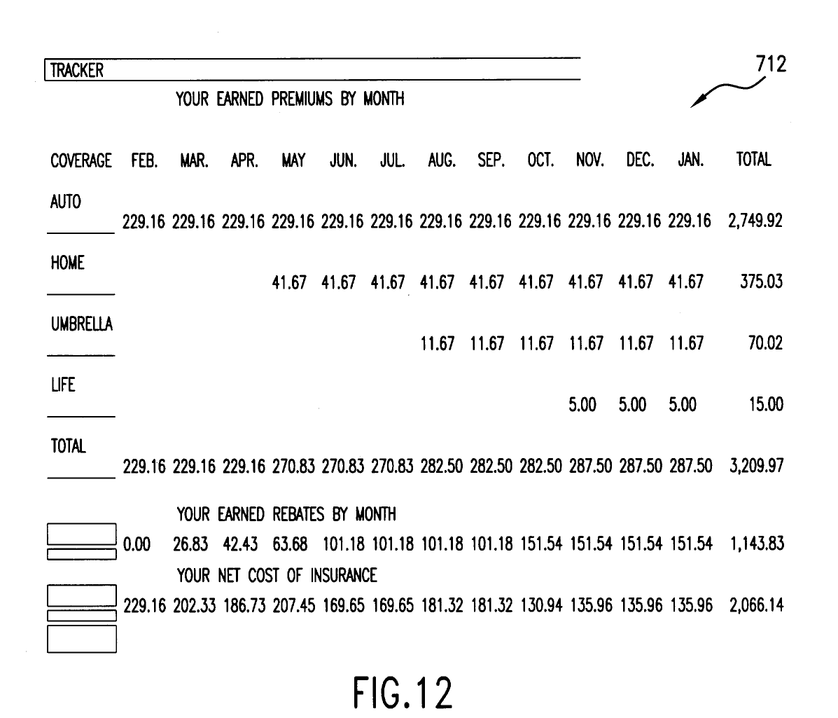

tracker (monthly account tracking), shown in FIG. 12.

The premium summary screen of block 708 also shown in FIG. 10, presents in block 714 the name and account number of the viewer and the valuation date of the account information being presented. It also presents a summary of the policy types in force, the annual premiums for each of the policies and the total annual premiums. This is not intended as the full accounting system, but only as a summary report. The full account management system may be available through other links.

The rebate summary screen of block 710 also shown in FIG. 11, presents in block 716 the names of each of the clients that have been referred by the viewer. For each client, it presents the coverages they have purchased, the annual premium for each of those coverages, the applicable and the calculated rebate percentages.

The “Tracker” screen of block 712 shown in FIG. 12, presents in block 718 the monthly accounting for premiums earned, rebates earned, and the net cost of insurance. This method for tracking the rebates and premiums is a unique method for managing the challenge of dealing with multiple transactions over time with varying initiation and termination dates. The monthly approach on an “earned” basis gives customers of Virtual Premium system an accurate and less complex representation of their current financial situation with premiums, rebates, and net cost.

As described supra, the Virtual Premium web site offers consumers the ability to comparison shop for automobile policies from among top insurance carriers. Using interactive forms, e-commerce functionality and quality security, Virtual Premium gives users a chance to review competitive policies for all the features expected of an automobile insurance policy.

Most insurances are eligible for rebates through the VP system. As such, there are several coverages which may be considered for Virtual Premium, including:

Auto

Homeowners

Homeowner's insurance is often placed with automobile coverage.

Tenant

When purchased, tenant insurance, like homeowners, is often bought from the same source as the auto coverage. When it is not purchased, it is often due to the fact that the individual is either unaware of the coverage or is deterred by the expected cost. In the VP model, customers are made aware of the opportunity through the web site. It will also give purchasers a place to spend their rebates should those referral rebates exceed the cost of the premiums on their entry coverage (e.g. auto).

Umbrella

Individual liability coverage may be made available through the site as an inexpensive option or one to absorb additional rebates.

Small Commercial

Small business owners may be interested in covering their commercial liabilities through the VP site. For even a small firm that refers its employees, it is feasible for a business owner to earn enough in rebates to offset the cost of his business coverages.

Large Commercial

Large commercial coverages where site visits and extensive client interaction may be necessary may be referred out for a split commission.

Ancillary Products and Services

Considering the audience and their reason for being on the Virtual Premium site, the obvious advantage to a user is the range of products that cater to this marketplace.

Although this invention has been described in connection with specific forms and embodiments thereof, it will be appreciated that various modifications other than those discussed above may be resorted to without departing from the spirit or scope of the invention. For example, equivalent elements may be substituted for those specifically shown and described, certain features may be used independently of other features, and in certain cases, particular locations of elements may be reversed or interposed, all without departing from the spirit or scope of the invention as defined in the appended claims.

What is claimed is:

1. A method for marketing regulated goods and services and for tracking earned incentives associated with purchasing of said goods and services over a computer network, the computer network having a central computer and a plurality of stations connected to said central computer, comprising the steps of:
receiving at said central computer from at least one of said plurality of the stations, a signal indicative of initialization of a referral activity by an owner of at least one item from said goods or services, said owner having an account in said central computer, said owner defining a referrer entity;
sending to the station associated with said referrer entity at least one electronic message formatted in compliance with a predefined rule or regulation and nominally directing a recipient of said electronic message to the opportunity to purchase a respective item of said regulated goods or services from an appropriate licensed entity, said respective item having an incentive feature associated therewith;
receiving from said referrer entity and storing in a data base at said central computer referral activity data associated with said referrer entity and with at least one referee entity;
receiving at said central computer from said referrer entity a signal indicative of approval of said at least one formatted electronic message;
sending said at least one formatted electronic message from said central computer to a station associated with said at least one referee entity;
matching said referrer entity with said at least one referee entity based on said referral activity data; and
electronically crediting said account associated with said referrer entity based on a predetermined incentive criteria associated with said referral activity once said respective item has been purchased by said at least one referee entity.

2. The method of claim 1, further comprising the steps of:
presenting to said at least one referee entity data representing said referrer entity for acceptance or declining by said at least one referee entity.

3. The method of claim 2, further comprising the step of:
crediting said account of said referrer entity upon acceptance of said referrer entity by said at least referee entity.

4. The method of claim 2, further comprising the steps of:
upon declining said referrer entity by said at least one referee entity, offering an alternative referrer entity to said at least one referee entity for acceptance, and
crediting an account of said alternative referrer entity upon acceptance of said alternative referrer entity.

5. The method of claim 4, further comprising the step of:
crediting said account of said referrer entity, if said at least one referee entity declines said alternative referrer entity.

6. The method of claim 1, further comprising the step of displaying the account information at said station of said referrer entity.

7. The method of claim 1, wherein said referral activity data has identification fields identifying said referrer entity and said at least one referee entity.

8. The method of claim 7, wherein said identification fields correspond to at least one of the electronic mail addresses of either said referrer entity or said at least one referee entity.

9. The method of claim 1, wherein said goods or services are marketed over the Internet, and said referral activity data is received from said plurality of stations running at least one Internet browser.

10. The method of claim 9, wherein said referral activity data is received at a server station running at least one database application.

11. The method of claim 1, wherein said respective item is an insurance policy.

12. The method of claim 11, wherein the insurance policy is a property casualty insurance policy.

13. The method of claim 11, wherein the insurance policy is a health or life insurance policy.

14. The method of claim 1, wherein said incentive feature of said respective item is a rebate feature.

15. The method of claim 1, wherein said predetermined incentive criteria is related to a rebate associated with the cost of said at least one item of said goods or services owned by said referrer entity.

16. The method of claim 15, wherein said cost of said at least one item of said goods or services is a premium of an insurance policy.

17. The method of claim 11, wherein said referral activity of said referrer entity involves announcing at least one of the incentive feature of the insurance policy to a third-party.

18. The method of claim 6, further comprising the step of:
displaying premium summary information associated with said account of said referrer entity.

19. The method of claim 6, further comprising the step of:
displaying rebate summary information associated with referral activity of said referrer entity.

20. The method of claim 6, further comprising the step of:
displaying information associated with earned incentives by said referrer entity.

21. A method for marketing insurance policies and for processing insurance-policy related information, comprising the steps of:
offering to an object of a qualifying activity, in a form of an electronic message formatted in compliance with predefined regulation, an insurance policy having a rebate feature associated with reducing the net insurance premium, said rebate feature being activated if said qualifying activity is performed by a holder of said insurance policy, said electronic message being e-mailed upon approval thereof by said insurance policy holder;
receiving data associated with said qualifying activity performed by said insurance policy holder;
calculating rebate data associated with the premium of said insurance policy based on said received qualifying activity data; and
presenting to said insurance policy holder discount information based on said calculated rebate data.

22. The method of claim 21, wherein said qualifying activity includes a referral activity, further comprising the steps of:
calculating the rebate associated with the premium of said insurance policy based on a predetermined incentive criteria associated with the referral activity;
crediting an account of said insurance policy holder with the rebate; and
displaying said insurance holder account information.

23. The method of claim 22, wherein said insurance policy is offered over the Internet, and said insurance policy holder related data is inputted via at least one Internet browser.

24. The method of claim 22, wherein said insurance policy holder related data is received at a server running at least one database application.

25. A system for marketing regulated products and for tracking earned incentives associated with purchasing of said products, comprising:
a central computer,
a plurality of stations connected to said central computer in a computer network, each said station being associated with a respective current holder of at least one of said products, said respective holder having an account associated therewith,
means at said central computer for sending to said stations electronic messages formatted in compliance with a predefined regulation, said electronic messages nominally directing recipients thereof to the opportunity to purchase a respective item of said regulated products from a licensed entity,
means at said central computer for receiving from said stations and storing at said central computer referral activity data associated with said respective current holder of said at least one of said products and with at least one prospective holder of said respective item;
means for sending said formatted electronic messages from said central computer to a station associated with said at least one prospective holder of said respective item upon approval by said respective current holder;
means at said central computer for matching said respective current holder with said prospective holder based on said referral activity data; and
means at said central computer for calculating and crediting said respective current holder's account, once said respective item has been purchased by said prospective holder.

26. The system of claim 25, further comprising a display for displaying information regarding said respective current holder account.
